(19) United States
(12) Patent Application Publication
(10) Pub. No.: US 2025/0220026 A1
(43) Pub. Date: Jul. 3, 2025

(54) DETECTING SECURITY THREATS ON RESOURCE-CONSTRAINED APPLIANCES

(71) Applicant: Stairwell, Inc., Mountain View, CA (US)

(72) Inventor: Michael Joseph Wiacek, Santa Clara, CA (US)

(21) Appl. No.: 19/005,209

(22) Filed: Dec. 30, 2024

Related U.S. Application Data
(60) Provisional application No. 63/616,116, filed on Dec. 29, 2023.

(51) Int. Cl. H04L 9/40

(52) U.S. Cl. CPC H04L 63/1416

(57) ABSTRACT

Methods, systems, and storage media for detecting security threats on resource-constrained devices are disclosed. Exemplary implementations may: monitor a resource-constrained device for new files; identify a new file based on the monitoring; transmit the new file to a cloud-based platform; analyze, in the cloud-based platform, the new file for threats in the device; and detect, based on the analyzing, a potential compromise in the device.

### CROSS-REFERENCE TO RELATED APPLICATIONS

This application claims the benefit of U.S. Provisional Patent Application No. 63/616,116, filed on Dec. 29, 2023, the disclosures of all of these applications and patents are incorporated by reference herein.

### TECHNICAL FIELD

The present disclosure generally relates to cybersecurity, and more particularly to implementing a lightweight solution for detecting security threats on resource-constrained devices.

### BACKGROUND

In the field of computer security, devices and systems are often equipped with software designed to prevent or detect malicious activity. Depending on the configurations, this security detection software may not be able to run on certain devices due to factors such as the unavailability of necessary compute power, inability to install the software, incompatibility between the software and the devices, or compile complexity. Additionally, operating systems running on the devices may prevent the security detection software from being installed for attack detection. Deploying security detection software could also impede the function of the devices, leading to a situation where systems can pull or copy files from the device and submit them to a secondary device for analysis by the security detection software. However, this process may increase utilization, storage, cost, and memory footprint at the device.

### BRIEF SUMMARY

The subject disclosure provides for systems and methods for cybersecurity. Exemplary implementations address the limitations of traditional security detection tools on resource-constrained devices, ensuring that the primary function of the device is not compromised. For example, some implementations may minimize the impact on device performance by offloading intensive processing tasks to a cloud-based artificial intelligence/machine learning (AI/ML) system, allowing for sophisticated threat detection while maintaining low resource usage on the device itself.

One aspect of the present disclosure relates to a method for detecting security threats on resource-constrained devices. The method may include monitoring, via a security agent, a resource-constrained device for an appearance of new files. The method may include identifying a new file based on the monitoring. The method may include transmitting the new file to a cloud-based platform. The method may include analyzing, in the cloud-based platform, the new file for threats in the device. The method may include detecting, based on the analyzing, a potential compromise in the device.

Another aspect of the present disclosure relates to a system configured for detecting security threats on resource-constrained devices. The system may include a non-transient computer-readable storage medium having executable instructions embodied thereon. The system may include one or more hardware processors configured to execute the instructions. The processor(s) may execute the instructions to monitor, via a security agent, a resource-constrained device for an appearance of new files. The processor(s) may execute the instructions to identify a new file based on monitoring of the device. The processor(s) may execute the instructions to transmit the new file to a cloud-based platform. The processor(s) may execute the instructions to analyze, in the cloud-based platform, the new file for threats in the device. The processor(s) may execute the instructions to detect, based on an analysis of the device, a potential compromise in the device.

Yet another aspect of the present disclosure relates to a system configured for detecting security threats on resource-constrained devices. The system may include means for monitoring, via a security agent, a resource-constrained device for an appearance of new files. The system may include means for identifying a new file based on the monitoring. The system may include means for transmitting the new file to a cloud-based platform. The system may include means for analyzing, in the cloud-based platform, the new file for threats in the device. The system may include means for detecting, based on the analyzing, a potential compromise in the device.

Still another aspect of the present disclosure relates to a non-transient computer-readable storage medium having instructions embodied thereon, the instructions being executable by one or more processors to perform a method of detecting security threats on resource-constrained devices. The method may include monitoring, via a security agent, a resource-constrained device for an appearance of new files. The method may include identifying a new file based on the monitoring. The method may include transmitting the new file to a cloud-based platform. The method may include analyzing, in the cloud-based platform, the new file for threats in the device. The method may include detecting, based on the analyzing, a potential compromise in the device.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a block diagram illustrating an overview of an environment in which some implementations of the disclosed technology can operate.

FIG. 2 illustrates a method for detecting unseen attacks, in accordance with one or more implementations.

FIG. 3 illustrates a system configured for detecting security threats on resource-constrained devices, in accordance with one or more implementations.

FIG. 4 illustrates an example flow diagram for detecting security threats on resource-constrained devices, according to certain aspects of the disclosure.

FIG. 5 is a block diagram illustrating an example computer system (e.g., representing both client and server) with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

### General Overview

Traditional security detection software cannot run on certain devices due to limited compute capacity, incompatibility, or other constraints. This limitation exposes these devices to potential attacks. For example, security detection techniques may require installing large security packages that communicate with devices to detect threats. Using these security detection techniques, without the ability to run directly on the devices, it becomes difficult to detect threats that are running directly on the devices and/or devices due to a lack of visibility of what is on the devices.

Embodiments disclosed herein provide a solution to the above identified problem involving a lightweight detection system designed to run directly on devices with limited compute capacity (i.e., resource constrained devices). Resource constrained devices may include, but are not limited to, embedded devices like Industrial Control Systems (ICS), Operational Technology (OT), and Supervisory Control and Data Acquisition (SCADA) systems. The detection system is built to detect threats on the device and perform analysis of collected data on the cloud (e.g., in a cloud-based ML system) without requiring intermediate processing or storage of data on the device. This minimizes the impact on a device's performance and ensures that the primary function of the device is not compromised while detecting malicious actors. The software can be installed on various devices including, for example, embedded systems (e.g., IOT/OT systems) and Kubernetes containers, without significant resource usage.

According to embodiments, the detection system may be configured to ingest executable or executable-like files in an organization's environment and store the files within a private, cloud-based data lake. As such, the system may detect and respond to threats on any infrastructure used within a specified network. The detection system may perform advanced AI/ML-supported analysis of the stored files, providing continuous and retroactive threat detection and response capabilities. Files may be analyzed, for example, at the binary level.

According to embodiments, the detection system may deploy file monitoring software on resource constrained devices. The software may identify new files on the devices and transmit the files, copies of the files, and/or metadata of the files to a remote server for further analysis, thus alleviating the processing burden from the device to, for example, a cloud server. The detection software is lightweight and can thus run on resource constrained devices. The lightweight design of the software ensures that the system runs efficiently on the device while preserving the primary functions of the device. In some embodiments, the system may perform periodic scans, for example, during off-peak hours or time periods with low utilization. In some embodiments, the system may be configured to disable certain operations during specified time windows of high utilization (e.g., critical business processing hours).

In some embodiments, the device, a file database, or the like, may be scanned for copies of identified files to detect other potential compromise or related incidents of the identified files. In some embodiments, the network or environment may be scanned for copies of identified files to detect potential compromise.

### Example Architecture

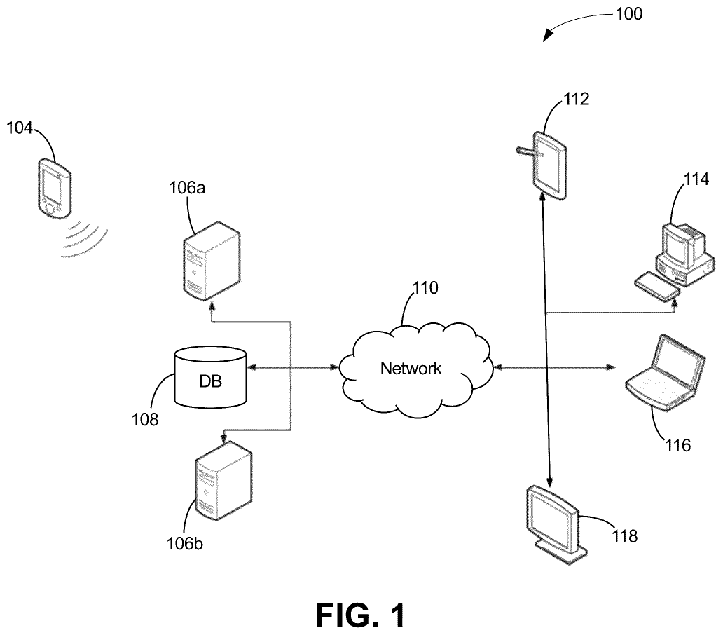

FIG. 1 is a block diagram illustrating an overview of an environment 100 in which some implementations of the disclosed technology can operate. The environment 100 can include one or more client computing devices, mobile device 104, tablet 112, personal computer 114, laptop 116, desktop 118, and/or the like. Client devices may communicate wirelessly via the network 110. The client computing devices can operate in a networked environment using logical connections through network 110 to one or more remote computers, such as server computing devices.

In some implementations, the environment 100 may include a server such as an edge server which receives client requests and coordinates fulfillment of those requests through other servers. The server may include the server computing devices 106a-106b, which may logically form a single server. Alternatively, the server computing devices 106a-106b may each be a distributed computing environment encompassing multiple computing devices located at the same or at geographically disparate physical locations. The client computing devices and server computing devices 106a-106b can each act as a server or client to other server/client device(s). The server computing devices 106a-106b can connect to a database 108 or can comprise its own memory. Each server computing devices 106a-106b can correspond to a group of servers, and each of these servers can share a database 108 or can have their own database 108. The database 108 may logically form a single unit or may be part of a distributed computing environment encompassing multiple computing devices that are located within their corresponding server, located at the same, or located at geographically disparate physical locations.

The network 110 can be a local area network (LAN), a wide area network (WAN), a mesh network, a hybrid network, or other wired or wireless networks. The network 110 may be the Internet or some other public or private network. Client computing devices can be connected to network 110 through a network interface, such as by wired or wireless communication. The connections can be any kind of local, wide area, wired, or wireless network, including the network 110 or a separate public or private network.

In some examples, resource-constrained devices, including embedded systems and specialized devices, may lack the computational power necessary to support traditional security software. In the present disclosure, the terms “device” and “platform” may be used interchangeably. These devices are integral to various critical functions within organizations, yet their inability to run resource-intensive security solutions may leave them vulnerable to cyber threats. Attackers may exploit this vulnerability, as the absence of security measures on such devices presents a blind spot in an organization's defense strategy. The limitations of existing security solutions, which are designed for more robust computing environments, do not address the unique challenges faced by these lightweight devices. Consequently, there may be a significant gap in the protection of such devices, which are increasingly targeted by sophisticated cyber-attacks.

The subject disclosure provides for systems and methods for cybersecurity. Exemplary implementations address the limitations of traditional security detection tools on resource-constrained devices, ensuring that the primary function of the device is not compromised. For example, some implementations may minimize the impact on device performance by offloading intensive processing tasks to a cloud-based AI/ML system, allowing for sophisticated threat detection while maintaining low resource usage on the device itself.

Implementations described herein address the aforementioned shortcomings and other shortcomings by providing a security solution tailored to the constraints of resource-limited devices. By introducing a lightweight detection software, some implementations may enable direct operation on these devices without the substantial computational overhead typically associated with traditional security tools. The software may adopt a detection-only approach, focusing solely on the identification of potential threats. This approach may significantly reduce the resource burden on the device, ensuring that its primary functions remain unaffected.

Subsequent to the detection phase, some or all analysis may be offloaded to the cloud, where advanced processing capabilities are available without taxing the limited resources of the device. This cloud-based analysis may allow for a comprehensive examination of potential threats, leveraging the scalability and power of cloud computing. Some implementations thus may provide a novel solution that bridges the gap in security for devices that were previously unable to support such measures. They may offer organizations the ability to extend their security perimeter to include all devices within their network, ensuring a more robust and inclusive defense against cyber threats.

According to some implementations, a system is designed to provide security monitoring for devices with limited computational resources. This system may focus on the detection of potential security threats. All intensive analysis of potential threats may be conducted in a cloud-based environment, which allows the system to operate without significantly impacting the performance of the device it is protecting.

The system may be engineered to have a minimal impact on the device's resources, ensuring that the primary functions of the device are not disrupted. It may operate in a way that is intended to be unnoticeable to the normal functioning of the device, avoiding excessive consumption of memory or computational power.

Selective scanning may be a feature of the system, which can be configured to focus only on new files that appear on the system, rather than scanning the entire system's history (e.g., executing a “back scan”). This may help to reduce the impact on the device's performance. The system may utilize specific points of interaction with the operating system, known as ‘hooks’ to efficiently monitor for new files without the need for extensive system scanning.

The system may include the capability to perform scans periodically during times when the device is least utilized, such as off-peak hours. This scheduling may help to minimize the impact on the device's performance during busy operational periods. In the event of a potential security compromise, the system may provide recommendations for how to respond to the incident, allowing for informed decision-making.

During the initial setup, the system may automatically identify and list known good files, creating an exclusion list through the use of AI/ML algorithms. There may be an onboarding mode, where the system enumerates files but does not send them for cloud processing, which can be used to power automated whitelisting without impacting cloud resources.

The system may offer continuous and retrospective threat detection capabilities by ingesting every executable or executable-like file on a resource constrained device and storing it in a private, cloud-based data lake. It may include a command-line interface or utility that allows for programmable interaction with the operating platform, enabling automation and integration with various environments.

The system may be configured to disable its monitoring agent entirely during certain periods of high utilization to ensure that there is no impact on the device during critical processing windows. It may be designed to be compatible with a wide range of devices, including those that typically do not support traditional security tools.

The system may be adaptable to run on lightweight platforms and can be installed in cloud-native environments, such as container environments for monitoring purposes. It may require less processing time, which is beneficial for resource-constrained devices. The system may be supported by a wide range of applications and may be implemented on various lightweight platforms and devices. It may include a configuration to disable the agent entirely during certain windows or periods of high utilization.

The system may include automatic enumeration of the system during onboarding to produce an automated exclusion list and may install in the onboarding mode which enumerates files but does not send them for processing into the cloud. This may power the automated whitelisting.

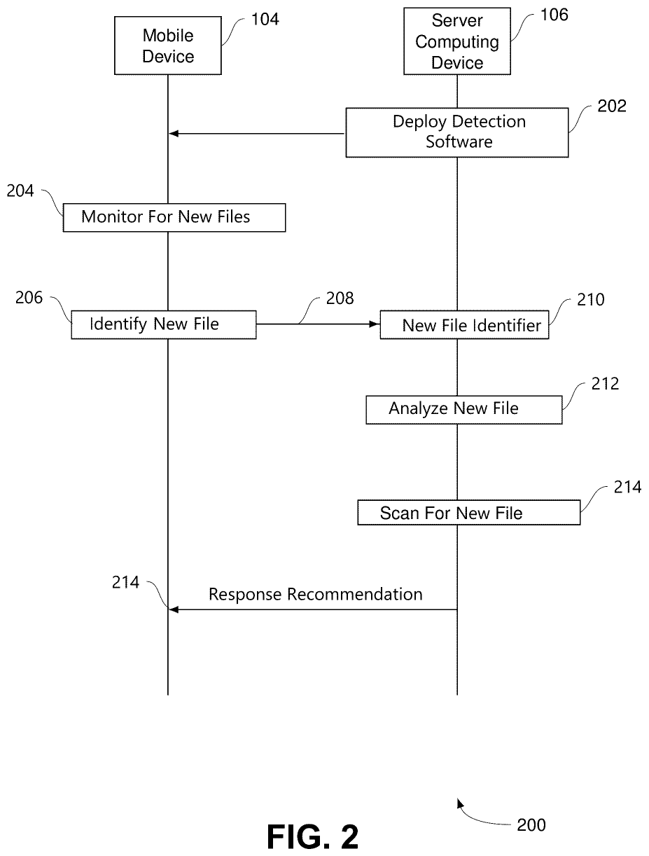

FIG. 2 illustrates a method 200 for detecting unseen attacks in a security detection system, in accordance with one or more implementations. For explanatory purposes, the example method 200 is described herein with reference to FIG. 1. Further for explanatory purposes, the operations of the example method 200 are described herein as occurring in serial, or linearly. However, multiple instances of the example method 200 may occur in parallel. For purposes of explanation of the subject technology, the method 200 will be discussed in the context of device 104 and server computing device 106; however, the method 200 may involve any constrained device including, but not limited to, a container, device, or embedded device (e.g., device 104, tablet 112, personal computer 114, laptop 116, desktop 118, and/or the like).

At operation 202, the server computing device 106 may deploy a detection software onto the device 104, detecting new files at the device 104. The detection software is lightweight and can thus run directly on resource constrained devices without impacting its primary functions. According to some embodiments, the server computing device 106 can determine a compute capacity necessary to deploy the detection software at the device 104 based on operating requirements of the software (in documentation or the like). The compute capacity may correspond to a threshold or range. In some implementations, a user of the device 104 may analyze current resource usage of the device 104 against the compute capacity to establish if the device's capabilities are sufficient for certain tasks. In some implementations, the user may compare a processor speed, memory availability, and storage space of the device 104 to the threshold or range that has been set to ensure compatibility with a server computing device 106.

At operation 204, the server computing device 106 (via the detection software) may monitor the device 104 for the appearance of new files. In some embodiments, the deployed detection software may include a file collector. The server computing device 106 may install the file collector at the device 104. The file collector may monitor the device 104 and determine that a file has never been sighted before. This may serve as an indicator that the file may be suspicious. The file collector may be configured to communicate with the server computing device 106 and transmit new file(s) to the server computing device 106. A new file may be stored in disk. In some implementations, the new file is stored only in memory (i.e., not stored in disk). The file may include any file, executable file, or the like.

At operation 206, the detection software (or file collector) may identify a new file based on the monitoring. At operation 208, the identified file is transmitted to the server computing device 106 for further analysis. The server computing device 106 may be a remote, cloud-based server or the like. In this manner, the software runs directly on the device without requiring intermediate processing or storage of data on the device and offloads intense processing tasks to a cloud-based ML system for analysis. The detection software looks for new files, and sends them to a remote server for analysis, shifting the security tools to the server.

According to some embodiments, based on the device 104, the server computing device 106 may run periodic scans for files during off-peak hours to minimize impact on the device's performance. According to some embodiments, the server computing device 106 may disable the file collector during critical business processing windows to further reduce impact. According to some embodiments, the server computing device 106 may disable the file collector during high-utilization periods to further reduce impact.

According to some embodiments, the file collector may operate according to an onboarding enumeration mode. In an onboarding enumeration mode, the file collector may begin automatically scanning and enumerating new files in the device 104 during onboarding to produce an exclusion list (e.g., build a whitelist via ML). Files that are not included on the exclusion list may automatically be sent to the server computing device 106. In this case, the file collector assumes the device 104 does not contain malicious/suspicious files at startup time and only collects new files that interact with the device 104 after the startup time.

At operation 210, the server computing device 106 may receive the new file from device 104 and derive an identifier from the new file (e.g., a hash). In some implementations, the server computing device 106 may utilize a hash function to create unique identifiers for each new file. The identifier may include file information such as file name, path, device number, etc. The identifier may be recorded at server computing device 106 where it is analyzed. In some implementations, the server computing device 106 may transmit the unique identifiers to the device 104. For example, the server computing device 106 may use a secure communication protocol to ensure the file identifier is safely received by the device 104.

At operation 212, the server computing device 106 may perform an analysis on the new file. In some implementations, the server computing device 106 may determine that the new file may pose a security threat to the device 104 based on the analysis. In some embodiments, the server computing device 106 may compare the file identifier with a local database of known file identifiers to determine if the file has been previously encountered or if it is a new potential threat.

According to some embodiments, the server computing device 106 may categorize the new file (e.g., vulnerable, suspicious, malicious, safe) based on the analysis. By non-limiting example, the server computing device 106 may identify that the device 104 is running vulnerable software that should be updated. As such, the file may be categorized as vulnerable.

In some embodiments, server computing device 106 may utilize an AI/ML model to analyze the file. In some embodiments, the server computing device 106 may utilize a database of known security threats to compare against the file attributes. In some implementations, the server computing device 106 may utilize the identifiers for each new file, which may then be used to compare against a database of known threats maintained by the server computing device 106. In some implementations, the server computing device 106 may apply heuristic analysis to the file to determine if it exhibits behavior commonly associated with malware. In some embodiments, the server computing device 106 may use signature-based detection methods to ascertain if the file matches any previously identified threat signatures.

At operation 214, the server computing device 106 may scan for copies of the new file in the database of the server computing device 106. The database may comprise a collection of new files from one or more machines in a network. In some embodiments, the server computing device 106 may utilize a predefined set of criteria to determine the similarity between the new file and other files present in the server computing device 106 database. In some implementations, the unique identifiers for each file are utilized to facilitate the comparison process.

At operation 216, the server computing device 106 may provide incident response recommendations based on analysis results of the file. In some implementations, the recommendation is provided when potential compromises are detected. In some implementations, the recommendation is provided according to a category the file is assigned to. In some implementations, the server computing device 106 identifies a file with a matching hash value that is associated with known malware, and may flag the file as potentially malicious.

The disclosed system(s) address a problem in traditional cybersecurity techniques tied to computer technology, namely, the technical problem of the inability to run security detection software on resource-constrained devices. The disclosed system solves this technical problem by providing a solution also rooted in computer technology, namely, by providing for detecting security threats on resource-constrained devices. The disclosed subject technology further provides improvements to the functioning of the computer itself because it improves processing and efficiency in cybersecurity.

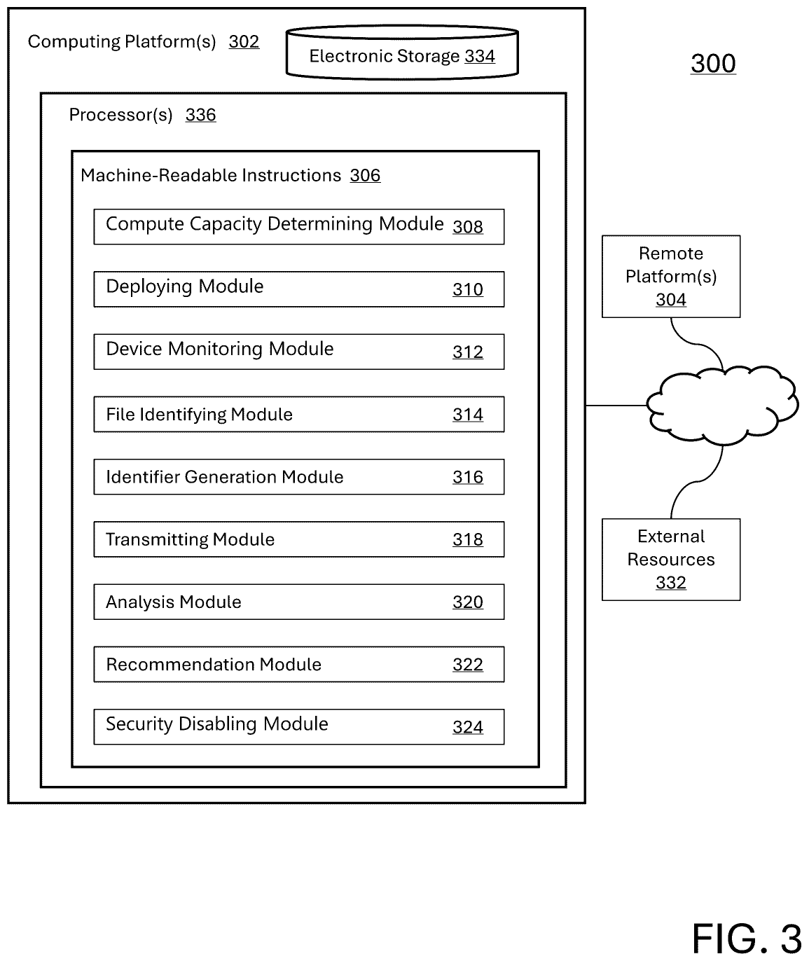

FIG. 3 illustrates a system 300 configured for detecting security threats on resource-constrained devices, according to certain aspects of the disclosure. In some embodiments, system 300 may include one or more computing platforms 302. Computing platform(s) 302 may be configured to communicate with one or more remote platforms 304 according to a client/server architecture, a peer-to-peer architecture, and/or other architectures. Remote platform(s) 304 may be configured to communicate with other remote platforms via computing platform(s) 302 and/or according to a client/server architecture, a peer-to-peer architecture, and/or other architectures. Users may access system 300 via remote platform(s) 304.

Computing platform(s) 302 may be configured by machine-readable instructions 306. Machine-readable instructions 306 may include one or more instruction modules. The instruction modules may include computer program modules. The instruction modules may include one or more of a compute capacity determining module 308, deploying module 310, device monitoring module 312, file identifying module 314, identifier generation module 316, transmitting module 318, analysis module 320, recommendation module 322, security disabling module 324, and/or other instruction modules.

Compute capacity determining module 308 may be configured to determine a compute capacity required to deploy a software configured to monitor and collect new files from a device.

Deploying module 310 may be configured to deploy a file collector on a resource constrained device.

Device monitoring module 312 may be configured to monitor the device for new files. According to some embodiments, new file collection may be performed during off-peak hours to minimize impact on the device's performance. In some embodiments, the device may be scanned for files during off-peak hours to minimize impact on the device's performance.

File identifying module 314 may be configured to identify a new file based on the device monitoring. The new file may indicate a suspicious or malicious file and thus would require further analysis.

Identifier generation module 316 may be configured to generate a unique identifier for the new file based on its content or metadata.

Transmitting module 318 may be configured to transmit the identified file to a cloud-platform. By transmitting the file to the cloud-platform, anything newly observed (e.g., from the latest dropper to a one-line file/web shell) can be analyzed out of band without the risk of a false positive causing operational disruption at the device.

Analysis module 320 may be configured to analyze, in the cloud-platform, the file for threats. The cloud-platform may comprise a cloud-based AI/ML system implementing security detection based on a data lake of executable files to analyze the identified file. The analysis may include comparing the file against a database of known security threats to confirm its status as a potential compromise. The potential compromise may include an unknown attack or security threat to the device.

According to some embodiments, the system 300 may be further configured to determine and assign the file to a category based on an analysis of the file (e.g., by analysis module 320). By non-limiting example, files may be categorized as vulnerable, suspicious, or clear. In some embodiments, the system 300 may be further configured to determine a score for the file and may assign the file a score indicating likelihood of maliciousness.

According to some embodiments, the analysis module 320 may be further configured to scan the device for copies of the file against a database of file identifiers known to the device. According to embodiments, the analysis module 320 may be further configured to scan a file database for copies of the identified file, and/or scan one or more devices within a computing environment for copies of the identified file. According to some embodiments, scanning of the device for files may be performed during off-peak hours to minimize impact on the device's performance.

Recommendation module 322 may be configured to generate an incident response recommendation in response to detecting the potential compromise in the device.

Security disabling module 324 may be configured to disable a security agent on the device during predetermined high-utilization periods to reduce operational impact.

In some embodiments, computing platform(s) 302, remote platform(s) 304, and/or external resources 332 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 302, remote platform(s) 304, and/or external resources 332 may be operatively linked via some other communication media.

A given remote platform 304 may include one or more processors configured to execute computer program modules. The computer program modules may be configured to enable an expert or user associated with the given remote platform 304 to interface with system 300 and/or external resources 332, and/or provide other functionality attributed herein to remote platform(s) 304. By way of non-limiting example, a given remote platform 304 and/or a given computing platform 302 may include one or more of a server, a desktop computer, a laptop computer, a handheld computer, a tablet computing platform, a NetBook, a Smartphone, a gaming console, and/or other computing platforms.

External resources 332 may include sources of information outside of system 300, external entities participating with system 300, and/or other resources. In some embodiments, some or all of the functionality attributed herein to external resources 332 may be provided by resources included in system 300.

Computing platform(s) 302 may include electronic storage 334, one or more processors 336, and/or other components. Computing platform(s) 302 may include communication lines, or ports to enable the exchange of information with a network and/or other computing platforms. Illustration of computing platform(s) 302 in FIG. 3 is not intended to be limiting. Computing platform(s) 302 may include a plurality of hardware, software, and/or firmware components operating together to provide the functionality attributed herein to computing platform(s) 302. For example, computing platform(s) 302 may be implemented by a cloud of computing platforms operating together as computing platform(s) 302.

Electronic storage 334 may comprise non-transitory storage media that electronically stores information. The electronic storage media of electronic storage 334 may include one or both of system storage that is provided integrally (i.e., substantially non-removable) with computing platform(s) 302 and/or removable storage that is removably connectable to computing platform(s) 302 via, for example, a port (e.g., a USB port, a firewire port, etc.) or a drive (e.g., a disk drive, etc.). Electronic storage 334 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 334 may include one or more virtual storage resources (e.g., cloud storage, a virtual private network, and/or other virtual storage resources). Electronic storage 334 may store software algorithms, information determined by processor(s) 336, information received from computing platform(s) 302, information received from remote platform(s) 304, and/or other information that enables computing platform(s) 302 to function as described herein.

Processor(s) 336 may be configured to provide information processing capabilities in computing platform(s) 302. As such, processor(s) 336 may include one or more of a digital processor, an analog processor, a digital circuit designed to process information, an analog circuit designed to process information, a state machine, and/or other mechanisms for electronically processing information. Although processor(s) 336 is shown in FIG. 3 as a single entity, this is for illustrative purposes only. In some embodiments, processor(s) 336 may include a plurality of processing units. These processing units may be physically located within the same device, or processor(s) 336 may represent processing functionality of a plurality of devices operating in coordination. Processor(s) 336 may be configured to execute modules 308, 310, 312, 314, 316, 318, 320, 322, and/or 324, and/or other modules. Processor(s) 336 may be configured to execute modules 308, 310, 312, 314, 316, 318, 320, 322, and/or 324, and/or other modules by software; hardware; firmware; some combination of software, hardware, and/or firmware; and/or other mechanisms for configuring processing capabilities on processor(s) 336. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 308, 310, 312, 314, 316, 318, 320, 322, and/or 324 are illustrated in FIG. 3 as being implemented within a single processing unit, in embodiments in which processor(s) 336 includes multiple processing units, one or more of modules 308, 310, 312, 314, 316, 318, 320, 322, and/or 324 may be implemented remotely from the other modules. The description of the functionality provided by the different modules 308, 310, 312, 314, 316, 318, 320, 322, and/or 324 described below is for illustrative purposes, and is not intended to be limiting, as any of modules 308, 310, 312, 314, 316, 318, 320, 322, and/or 324 may provide more or less functionality than is described. For example, one or more of modules 308, 310, 312, 314, 316, 318, 320, 322, and/or 324 may be eliminated, and some or all of its functionality may be provided by other ones of modules 308, 310, 312, 314, 316, 318, 320, 322, and/or 324. As another example, processor(s) 336 may be configured to execute one or more additional modules that may perform some or all of the functionality attributed below to one of modules 308, 310, 312, 314, 316, 318, 320, 322, and/or 324.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

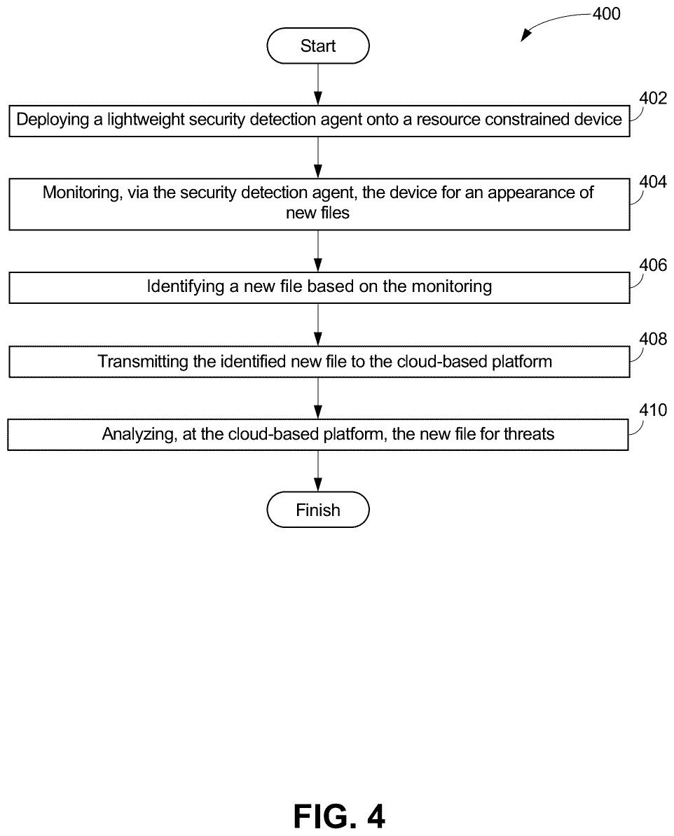

FIG. 4 illustrates an example flow diagram (e.g., process 400) for detecting security threats on resource-constrained devices, according to certain aspects of the disclosure. For explanatory purposes, the example process 400 is described herein with reference to FIGS. 1-3. Further for explanatory purposes, the steps of the example process 400 are described herein as occurring in serial, or linearly. However, multiple instances of the example process 400 may occur in parallel. For purposes of explanation of the subject technology, the process 400 will be discussed in reference to FIGS. 1-3.

An operation 402 may include deploying a lightweight security detection agent onto a resource constrained device. The security detection agent may run directly on the device and communicate with a cloud-based platform (e.g., server computing device 106).

An operation 404 may include monitoring, via the security detection agent, the device for an appearance of new files. The security detection agent may be configured to continuously monitor the device for unseen files for the device. According to some embodiments, the monitoring is performed during onboarding of new files. As such, the install (i.e., operation 402) on the device runs in a way that optionally does not back scan the device and only views new files forward. In some implementations, the monitoring may produce an exclusion list.

An operation 406 may include identifying a new file based on the monitoring. The new file may include, for example, any executable or executable like file on the device and may include any new or previously unseen file for the device. According to an aspect, the identifying of the file includes generating a unique identifier for the file based on its content or metadata. In some embodiments, generating the unique identifier may include calculating a hash of the new file. The hash may include file information such as file name, path, device number, etc. The hash may be recorded at the cloud-based platform where it is analyzed.

An operation 408 may include transmitting the identified new file to the cloud-based platform for further analysis. According to embodiments, all the new files are collected and transmitted to the cloud-based platform.

An operation 410 may include analyzing, at the cloud-based platform, the new file for threats. In some embodiments, determining if the file is a threat includes scanning the device for copies of the file, scanning the cloud-based platform for other copies or indicators of the file (e.g., from another application of the computing environment), or the like. Operation 410 may further include detecting potential compromise in the device based on the analysis. According to an aspect, the potential compromise is an unknown attack or security threat to the device.

According to an aspect, the process 400 may include scanning the device for new or previously unseen files during off-peak hours of the applicant to minimize impact on the device's performance.

According to an aspect, the process 400 may include generating an incident response recommendation in response to detecting the potential compromise in the device. The incident response recommendation may be transmitted to a provider of the device, computing environment, or user of the device.

According to an aspect, the process 400 may include disabling the security detection agent (e.g., a file collector) on the device during predetermined high-utilization periods to reduce operational impact.

According to an aspect, the analysis is performed using AI/ML techniques to continuously improve threat detection at the device.

According to an aspect, the analysis may indicate generating a score indicating likelihood of maliciousness. The analysis may further include determining that the file is potentially malicious, or unreasonably suspicious based on the score. According to some embodiments, the cloud-based platform may send a notification to the user of the device via an API, web hook, notice within our web UI, etc., based on the file being potentially malicious, or unreasonably suspicious.

According to an aspect, the process 400 may include tracking and monitoring an inventory of each device running the security detection agent. By non-limiting example, each time a new file is identified at a device (e.g., files X, Y, Z), sighting of the new file is recorded at the cloud-based platform (e.g., device A has file X, then Y, then Z). The record of the sighting may include a timestamp for when it was first seen and the time it was most recently seen.

According to an aspect, the security detection agent may monitor all incoming files directly on a device. The security detection agent may be facilitated and operated by the cloud-based platform.

According to an aspect, the analyzing of the file includes comparing the file against a database of known security threats to confirm its status as a potential compromise.

### Hardware Overview

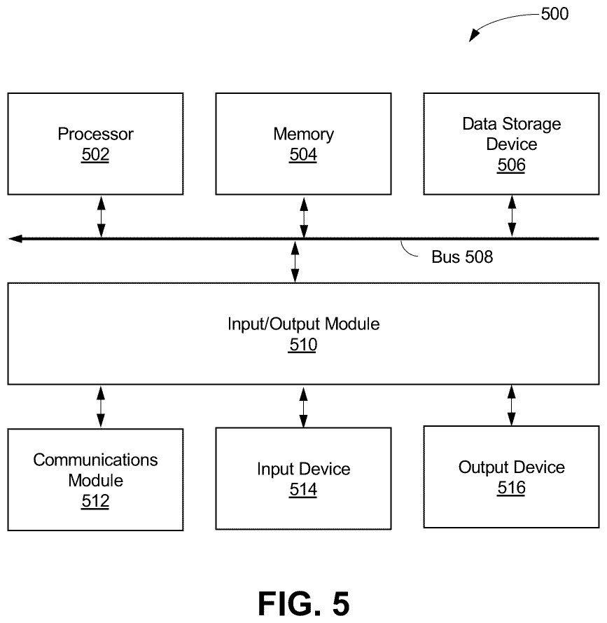

FIG. 5 is a block diagram illustrating an exemplary computer system 500 with which aspects of the subject technology can be implemented. In certain aspects, the computer system 500 may be implemented using hardware or a combination of software and hardware, either in a dedicated server, integrated into another entity, or distributed across multiple entities.

Computer system 500 (e.g., server and/or client) includes a bus 508 or other communication mechanism for communicating information, and a processor 502 coupled with bus 508 for processing information. By way of example, the computer system 500 may be implemented with one or more processors 502. Processor 502 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 500 can include, in addition to hardware, code that creates an execution environment for the computer program in question, e.g., code that constitutes processor firmware, a protocol stack, a database management system, an operating system, or a combination of one or more of them stored in an included memory 504, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 508 for storing information and instructions to be executed by processor 502. The processor 502 and the memory 504 can be supplemented by, or incorporated in, special purpose logic circuitry.

The instructions may be stored in the memory 504 and implemented in one or more computer program products, i.e., one or more modules of computer program instructions encoded on a computer-readable medium for execution by, or to control the operation of, the computer system 500, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 504 may also be used for storing temporary variable or other intermediate information during execution of instructions to be executed by processor 502.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 500 further includes a data storage device 506 such as a magnetic disk or optical disk, coupled to bus 508 for storing information and instructions. Computer system 500 may be coupled via input/output module 510 to various devices. The input/output module 510 can be any input/output module. Exemplary input/output modules 510 include data ports such as USB ports. The input/output module 510 is configured to connect to a communications module 512. Exemplary communications modules 512 include networking interface cards, such as Ethernet cards and modems. In certain aspects, the input/output module 510 is configured to connect to a plurality of devices, such as an input device 514 and/or an output device 516. Exemplary input devices 514 include a keyboard and a pointing device, e.g., a mouse or a trackball, by which a user can provide input to the computer system 500. Other kinds of input devices 514 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 516 include display devices such as an LCD (liquid crystal display) monitor, for displaying information to the user.

According to one aspect of the present disclosure, the above-described gaming systems can be implemented using a computer system 500 in response to processor 502 executing one or more sequences of one or more instructions contained in memory 504. Such instructions may be read into memory 504 from another machine-readable medium, such as data storage device 506. Execution of the sequences of instructions contained in the main memory 504 causes processor 502 to perform the process steps described herein. One or more processors in a multi-processing arrangement may also be employed to execute the sequences of instructions contained in memory 504. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 500 can include clients and servers. A client and server are generally remote from each other and typically interact through a communication network. The relationship of client and server arises by virtue of computer programs running on the respective computers and having a client-server relationship to each other. Computer system 500 can be, for example, and without limitation, a desktop computer, laptop computer, or tablet computer. Computer system 500 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 502 for execution. Such a medium may take many forms, including, but not limited to, non-volatile media, volatile media, and transmission media. Non-volatile media include, for example, optical or magnetic disks, such as data storage device 506. Volatile media include dynamic memory, such as memory 504. Transmission media include coaxial cables, copper wire, and fiber optics, including the wires that comprise bus 508. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 500 reads game data and provides a game, information may be read from the game data and stored in a memory device, such as the memory 504. Additionally, data from the memory 504 servers accessed via a network the bus 508, or the data storage 506 may be read and loaded into the memory 504. Although data is described as being found in the memory 504, it will be understood that data does not have to be stored in the memory 504 and may be stored in other memory accessible to the processor 502 or distributed among several media, such as the data storage 506.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A computer-implemented method, comprising:
monitoring, via a security agent, a resource-constrained device for an appearance of new files;
identifying a new file based on the monitoring;
transmitting the new file to a cloud-based platform;
analyzing, in the cloud-based platform, the new file for threats in the device; and
detecting, based on the analyzing, a potential compromise in the device.

2. The method of claim 1, further comprising scanning the device for all previously unseen files during off-peak hours of the device.

3. The method of claim 1, further comprising:
generating an incident response recommendation in response to detecting the potential compromise in the device; and
transmitting the incident response recommendation to a provider of the device.

4. The method of claim 1, further comprising disabling the security agent on the device during predetermined high-utilization periods.

5. The method of claim 1, further comprising determining that the new file is a potentially malicious or unreasonably suspicious file based on the analysis at the cloud-based platform.

6. The method of claim 1, wherein the security agent is installed directly on the device and facilitated by the cloud-based platform.

7. The method of claim 1, wherein the potential compromise is an unknown attack or security threat to the device.

8. The method of claim 1, wherein the identifying the new file includes generating a hash of the new file to serve as a unique identifier for the new file based on its content or metadata.

9. The method of claim 1, further comprising comparing the new file against a database of known security threats to confirm its status as a potential compromise.

10. A system, the computing platform comprising:
a non-transient computer-readable storage medium having executable instructions embodied thereon; and
one or more hardware processors configured to execute the instructions to:
monitor, via a security agent, a resource-constrained device for an appearance of new files;
identify a new file based on monitoring of the device;
transmit the new file to a cloud-based platform;
analyze, in the cloud-based platform, the new file for threats in the device; and
detect, based on an analysis of the device, a potential compromise in the device.

11. The system of claim 10, wherein the one or more hardware processors are further configured by the instructions to:
scan the device for all previously unseen files during off-peak hours of the device.

12. The system of claim 10, wherein the one or more hardware processors are further configured by the instructions to:
generate an incident response recommendation in response to detecting the potential compromise in the device; and
transmit the incident response recommendation to a provider of the device.

13. The system of claim 10, wherein the one or more hardware processors are further configured by the instructions to:
disable the security agent on the device during predetermined high-utilization periods.

14. The system of claim 10, wherein the one or more hardware processors are further configured by the instructions to:
determine that the new file is a potentially malicious or unreasonably suspicious file based on the analysis at the cloud-based platform.

15. The system of claim 10, wherein the security agent is installed directly on the device and facilitated by the cloud-based platform.

16. The system of claim 10, wherein the potential compromise is an unknown attack or security threat to the device.

17. The system of claim 10, wherein the one or more hardware processors are further configured by the instructions to:
generate a hash of the new file to serve as a unique identifier for the new file based on its content or metadata.

18. The system of claim 10, wherein the one or more hardware processors are further configured by the instructions to:
compare the new file against a database of known security threats to confirm its status as a potential compromise.

19. A non-transitory computer-readable medium storing a program, which when executed by a computer, configures the computer to:
monitor, via a security agent, a resource-constrained device for an appearance of new files;
identify a new file based on monitoring of the device;
transmit the new file to a cloud-based platform;
analyze, in the cloud-based platform, the new file for threats in the device; and
detect, based on an analysis of the device, a potential compromise in the device.

20. The computer-readable storage medium of claim 19, wherein the program, when executed by a computer. further configures the computer to:
generate a hash of the new file to serve as a unique identifier for the new file based on its content or metadata.
